(19) United States
(12) Patent Application Publication
(10) Pub. No.: US 2025/0073809 A1
(43) Pub. Date: Mar. 6, 2025

(54) LASER PROCESSING APPARATUS

(71) Applicant: PlayNitride Display Co., Ltd., MiaoLi County (TW)

(72) Inventors: Yen-Mu Chen, MiaoLi County (TW); Chih-Chien Tung, MiaoLi County (TW)

(73) Assignee: PlayNitride Display Co., Ltd., MiaoLi County (TW)

(21) Appl. No.: 18/473,315

(22) Filed: Sep. 25, 2023

(30) Foreign Application Priority Data
Aug. 30, 2023 (TW) 112132662

(51) Int. Cl. B23K 26/06; G02B 26/08

(52) U.S. Cl. CPC B23K 26/0643; G02B 26/0816

(57) ABSTRACT

A laser processing apparatus provides a laser unit, a vibration mirror module, a focusing module, and a processing platform. The laser unit emits a laser pulse beam. The vibration mirror module, positioned on the path of the laser pulse beam, reflects the laser pulse beam and has a first mode and a second mode configured to reflect the laser pulse beam into a first beam while the module is in the first mode or alternatively, into a second beam while the module is in the second mode. The first beam and the second beam travel in different directions. The focusing module receives the second beam reflected by the vibration mirror module in the second mode and focuses the second beam onto a focus. The processing platform is positioned at the focus to bear a to-be-processed device, upon which the second beam is cast.

### CROSS-REFERENCE TO RELATED APPLICATION

This application claims the priority benefit of Taiwan application serial no. 112132662filed on Aug. 30, 2023. The entirety of the above-mentioned patent application is hereby incorporated by reference herein and made a part of this specification.

### BACKGROUND

### Technical Field

The disclosure relates to a processing apparatus, specifically to a laser processing apparatus.

### Description of Related Art

Certain laser pulse products nowadays face challenges in emission control.

Immediately after being activated, the products provide insufficient pulse energy for the initial emissions. Hence, certain manufacturing processes cannot benefit from these laser pulse products due to the fact that the manufacturing processes demand single emission with sufficient pulse energy to conduct processing. Utilizing these laser products in manufacturing process results in manufacturing process instability since insufficient laser pulse brings about unexpected effect on to-be-processed device.

To be more specific, the first few moments after a laser pulse product is activated, difference between certain laser pulse power and target power is observed. Generally, the laser pulse power falls short of target power. Insufficient laser pulse power adversely affects the stability and expectedness of manufacturing process outcome.

One of the existing solutions is to affix an electro-optical modulator onto the emission outlet of a laser apparatus, selectively enabling pulses to pass through by controlling on/off state of a light gate. The light gate is switched off before pulse laser reaches the stable state at rated power, and the light gate is switched on when pulse laser reaches rated power. Nonetheless, electro-optical modulators are costly and therefore, large-scale implementation of electro-optical modulators in mass production machine is impractical.

### SUMMARY

This disclosure provides a laser processing apparatus, which effectively enhances stability and variety of manufacturing process.

One embodiment of this disclosure presents a laser processing apparatus, including a laser unit, a vibration mirror module, a focusing module, a mask, and a processing platform. The laser unit is configured to emit a laser pulse beam. The vibration mirror module is positioned on a path of the laser pulse beam, configured to reflect the laser pulse beam and has a first mode and a second mode configured to selectively reflect the laser pulse beam into a first beam while being in the first mode or to selectively reflect the laser pulse beam into a second beam while being in the second mode. The first beam and the second beam travel in different directions. The focusing module receives the second beam reflected by the vibration mirror module in the second mode and focuses the second beam onto a focus. The mask is placed between the vibration mirror module and the focusing module and includes an aperture to enable at least a portion of the second beam to pass through. The processing platform is positioned at the focus and configured to bear a to-be-processed device. The second beam is cast upon the to-be-processed device.

One embodiment of the disclosure provides a laser processing apparatus, including a laser unit, a vibration mirror module, a focusing module, and a processing platform. The laser unit is configured to emit a laser pulse beam, which includes a first laser pulse beam and a second laser pulse beam. Energy of the first laser pulse beam is weaker than energy of the second laser pulse beam. The vibration mirror module is positioned on a path of the laser pulse beam, configured to reflect the laser pulse beam and has a first mode and a second mode configured to selectively reflect the first laser pulse beam into a first beam while being in the first mode or to selectively reflect the second laser pulse beam into a second beam while being in the second mode. The first beam and the second beam travel in different directions. The focusing module receives the second beam reflected by the vibration mirror module in the second mode and focuses the second beam onto a focus. The processing platform is positioned at the focus and configured to bear a to-be-processed device. The second beam is cast upon the to-be-processed device.

Stability of manufacturing process is effectively enhanced thanks to the laser processing apparatus in the disclosed embodiments, wherein the vibration mirror module selectively reflects the laser pulse beam into a first beam while being in the first mode or selectively reflects the laser pulse beam into a second beam while being in the second mode. As a result, the laser processing apparatus is able to reflect the second beam onto the focusing module for focusing. Variety of manufacturing process is also enriched since the laser processing apparatus in the disclosed embodiments enables different manufacturing process conditions with the first beam and the second beam.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a light path of a laser processing apparatus according to an embodiment of the disclosure.

FIG. 2 is a diagram depicting how energy of a laser pulse beam emitted by a laser unit in FIG. 1 varies with time.

FIG. 3 is a diagram depicting how energy of a laser pulse beam emitted by the laser unit in FIG. 1 varies with time in another application.

FIG. 4 is a schematic view of a light path of a laser processing apparatus according to another embodiment of this disclosure.

FIG. 5 is a schematic view of a light path of a laser processing apparatus according to yet another embodiment of this disclosure.

FIG. 6A is a schematic view of a light path of a second beam of a laser processing apparatus according to still another embodiment of this disclosure.

FIG. 6B is a schematic view of a partial light path of a first beam of the laser processing apparatus in FIG. 6A.

FIG. 7 is a schematic view of how the aperture is lowered according to a modified embodiment.

FIG. 8A is a schematic view of a light path of a second beam emitted by a laser processing apparatus according to another embodiment of this disclosure.

FIG. 8B is a diagram showing a distribution curve of normalized light density of laser pulse beam versus cross-sectional location in the laser processing apparatus in FIG. 8A.

FIG. 9A is a schematic view of a partial light path of the second beam reflected by a vibration mirror module in FIG. 8A in a second mode.

FIG. 9B is a schematic view of a partial light path of a first beam reflected by the vibration mirror module in FIG. 8A in a first mode.

FIG. 10 is a schematic view of a light path of a laser processing apparatus according to yet another embodiment of this disclosure.

FIG. 11A, FIG. 11B, and FIG. 11C are schematic cross-sectional views of a partial light path of a first beam in three other modified examples of the laser processing apparatus in FIG. 10.

### DESCRIPTION OF THE EMBODIMENTS

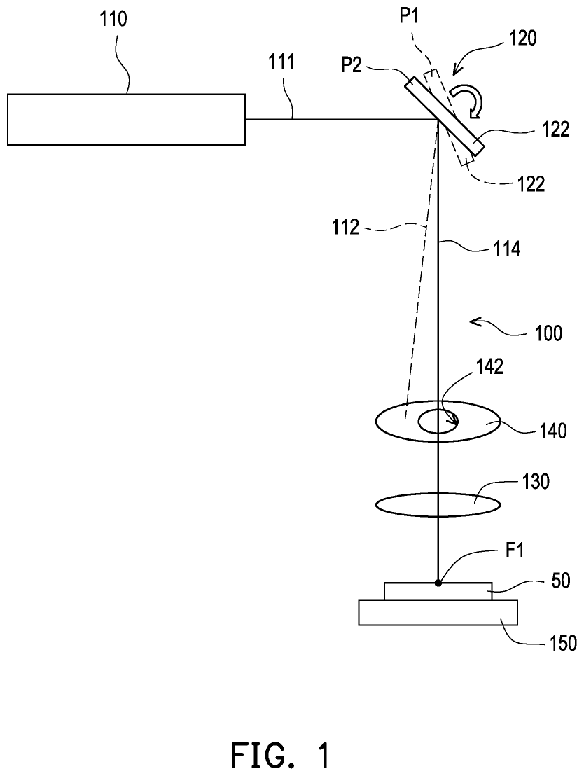

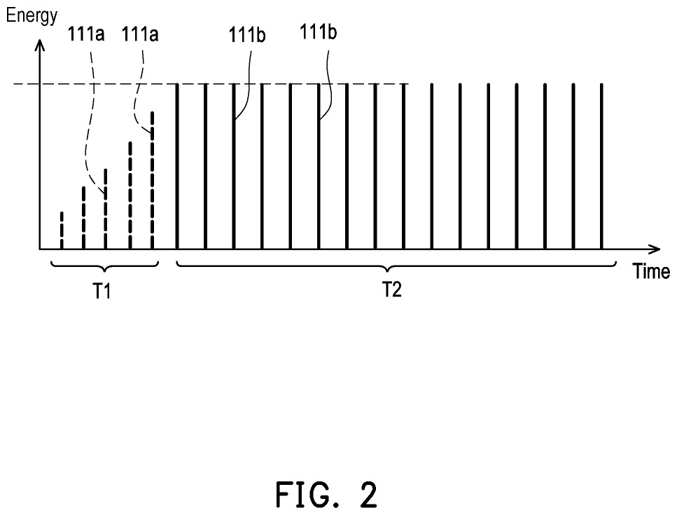

FIG. 1 is a schematic view of a light path of a laser processing apparatus according to an embodiment of the disclosure. FIG. 2 is a diagram depicts depicting how energy of a laser pulse beam emitted by a laser unit in FIG. 1 varies with time. As FIG. 1 and FIG. 2 indicate, a laser processing apparatus 100 of the embodiment includes a laser unit 110, a vibration mirror module 120, a focusing module 130, a mask 140, and a processing platform 150. The laser unit 110 emits a laser pulse beam 111. In this embodiment, the laser unit 110 is a laser beam source, which emits visible laser, infrared laser, ultraviolet laser, or laser of other wavelengths. The vibration mirror module 120 is positioned on the path of the laser pulse beam 111, reflects the laser pulse beam 111 and has a first mode and a second mode configured to selectively reflect the laser pulse beam 111 into a first beam 112 in the first mode or to selectively reflect the laser pulse beam 111 into a second beam 114 in the second mode. The first beam 112 and the second beam 114 travel in different directions. For example, the vibration mirror module 120 is at different rotation angles in the first mode and the second mode, respectively. For example, in the first mode, the vibration mirror module 120 rotates a vibration mirror 122 into a first position P1, while in the second mode, rotates the vibration mirror 122 into a second position P2.

The focusing module 130 receives the second beam 114 reflected by the vibration mirror module 120 in the second mode and focuses the second beam 114 onto a focus F1. In this embodiment, the focusing module 130 may be at least one lens element, e.g., a convex lens element. The mask 140 is placed between the vibration mirror module 120 and the focusing module 130, and includes an aperture 142 to allow at least a portion of the second beam 114 to pass through. In this embodiment, the first beam 112 is cast upon the mask 140. The mask 140 blocks the first beam 112, preventing the first beam 112 from being transmitted to the focusing module 130 and a to-be-processed device 50. In an embodiment, the mask 140 is a light absorber configured to absorb the first beam 112 or a portion of the second beam 114.

The processing platform 150 is positioned at the focus F1 to bear the to-be-processed device 50, and the second beam 114 is cast upon the to-be-processed device 50. The to-be-processed device 50 may include a light-emitting diode, a micro light-emitting diode, other electronic devices, or other to-be-processed devices.

In this embodiment, the laser pulse beam 111 emitted by the laser unit 110 includes a first laser pulse beam 111a and a second laser pulse beam 111b (indicated in FIG. 2). Specifically, the laser unit 110 requires a warm-up period T1. The initial emissions of the laser pulse beam 111 within the period T1 right after the laser unit 110 is activated are the first laser pulse beams 111a. Energy of the first laser pulse beam 111a is comparatively unstable. Within a period T2 following the period T1, the laser pulse beam 111 emitted by the laser unit 110 is the second laser pulse beam 111b. Energy of the second laser pulse beam 111b is stable as the energy reaches rated output power. In this embodiment, the energy of the first laser pulse beam 111a emitted during T1 is weaker than that of the second laser pulse beam 111b. Moreover, the first laser pulse beam 111a is reflected into the first beam 112 by the vibration mirror module 120 in the first mode, and the second laser pulse beam 111b is reflected into the second beam 114 by the vibration mirror module 120 in the second mode. Hence, in this embodiment, the first beam 112, whose energy is comparatively unstable or whose output power is insufficient, is not cast upon the to-be-processed device 50. Instead, the second beam 114 with stable energy is cast upon to-be-processed device 50. Consequently, the laser processing apparatus of this embodiment effectively enhances stability of manufacturing process.

In the laser processing apparatus of this embodiment, the vibration mirror module 120 is adopted, instead of a costly electro-optical modulator, in order to distinguish between the first beam 112 with comparatively unstable energy and the second beam 114 with stable energy. The vibration mirror module 120 is available at a lower cost in contrast to an electro-optical modulator. Thus, the cost of the laser processing apparatus is significantly reduced and large-scale implementation of the laser processing apparatus in mass production machine is feasible. In an embodiment, the vibration mirror module 120 is a mirror galvanometer. A mirror galvanometer measures the intensity of current passing through it in accordance with the angle or position of light reflection. The embodiment functions in a reverse manner, as the rotation angle of the vibration mirror 122 varies with different current intensities applied onto the mirror galvanometer and the angle of light reflection is therefore altered. A mirror galvanometer is available at a lower cost in contrast to an electro-optical modulator.

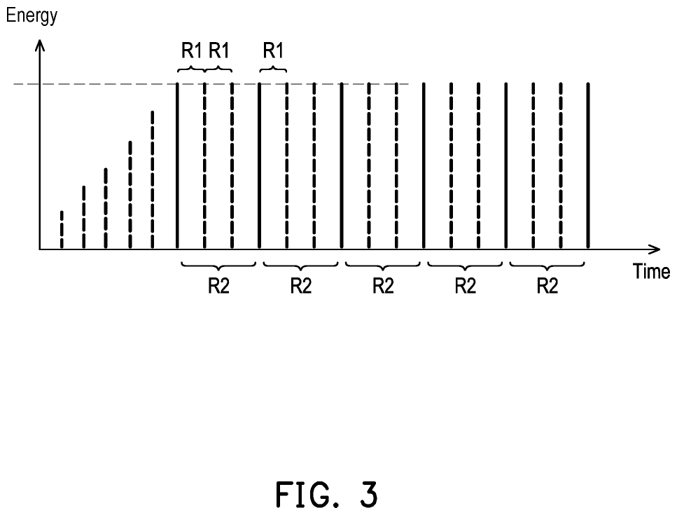

FIG. 3 is a diagram depicting how energy of the laser pulse beam emitted by the laser unit in FIG. 1 varies with time in another application. In an embodiment, the laser pulse beam 111 emitted by the laser unit 110 include multiple laser pulse beams with the first frequency. In the second frequency, the vibration mirror module 120 switches between the first mode and the second mode. In an embodiment, the second frequency is smaller than the first frequency, and the second mode overlaps time sequence of at least one of the laser pulse beams 111 with the first frequency. For example, the laser pulse beam 111 emitted by the laser unit 110 goes through a cycle R1, the first frequency being the reciprocal of R1. The vibration mirror module 120 switches from the first mode to the second mode as the vibration mirror module 120 goes through one single cycle R2, the second frequency being the reciprocal of R2. The to-be-processed device 50 does not receive the second beam 114 until the device goes through one single cycle R2. That is, the pulse repetition frequency of the laser pulse beam 111 drops from the first frequency to the second frequency. Hence, a frequency lowering or frequency dividing effect is achieved.

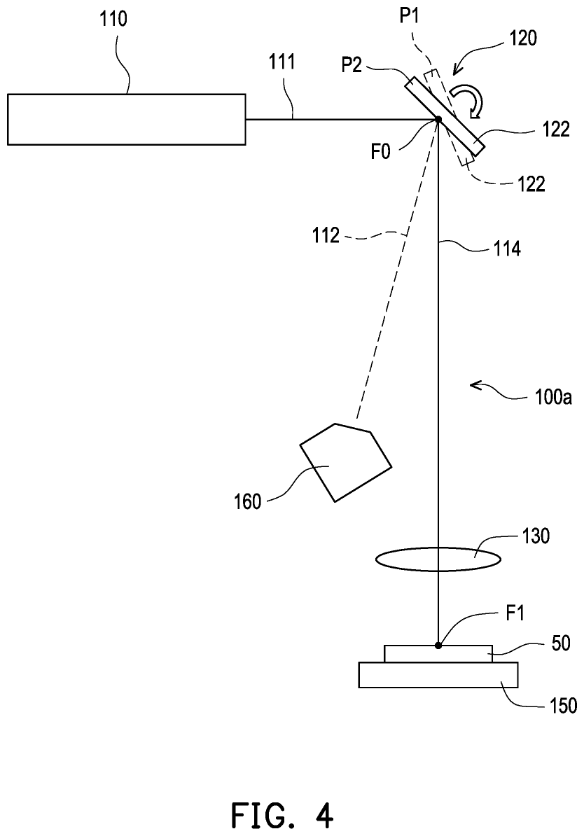

FIG. 4 is a schematic view of a light path of a laser processing apparatus according to another embodiment of this disclosure. As FIG. 4 indicates, a laser processing apparatus 100a of this embodiment is similar to the laser processing apparatus 100 in FIG. 1. The major difference between the laser processing apparatus 100 and the laser processing apparatus 100a is described as follows. The laser processing apparatus 100a does not have the mask 140 indicated in FIG. 1. In this embodiment, the first beam 112 reflected by the vibration mirror module 120 in the first mode deviates from the focusing module 130 and therefore is not transmitted upon the to-be-processed device 50. In this embodiment, the laser processing apparatus 100a further includes light absorber 160, which is positioned on the light path of the first beam 112. In certain embodiments, the focusing module 130 is further provided with a front focus F0 on a side close to the vibration mirror module 120. The front focus F0 and the focus F1 are two conjugate focuses, and F0 overlaps the convergence point of the laser pulse beam 111 and the vibration mirror module 120. As the vibration mirror module 120 switches between the first mode and the second mode, the vibration mirror 122 rotates around the convergence point as the center of axis. Thus, even if an error in angle positioning occurs while the vibration mirror module 120 is in the second mode, the second beam 114 traveling from the front focus F0 still returns to the focus F1 through the convergence of the focusing module 130. Consequently, influence of manufacturing process tolerance is mitigated.

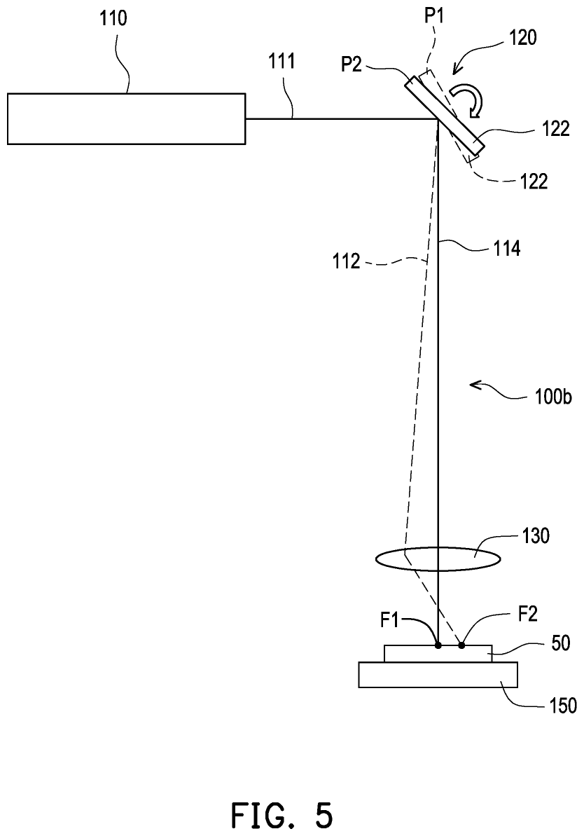

FIG. 5 is a schematic view of a light path of a laser processing apparatus according to yet another embodiment of this disclosure. As FIG. 5 indicates, a laser processing apparatus 100b is similar to the laser processing apparatus 100a in FIG. 4. The major difference between the laser processing apparatus 100a and the laser processing apparatus 100b is described as follows. In the laser processing apparatus 100b of this embodiment, the vibration mirror module 120 in the first mode enables the first beam 112 to enter the focusing module 130 at an incident angle different from that of the second beam 114 entering the focusing module 130 while the vibration mirror module 120 is in the second mode. The vibration mirror module 120 switches between the first mode and the second mode in order to alter the location of the focus on a focusing plane. For example, the focusing module 130 receives the second beam 114 entering the module at normal incidence, creating the focus F1 on the to-be-processed device 50. Besides, the focusing module 130 receives the first beam 112 entering the module at oblique incidence, creating the focus F2 on the to-be-processed device 50. The location of the focus F2 differs from that of the focus F1. Consequently, with the switching of the vibration mirror module 120, processing is conducted at different locations on the to-be-processed device 50. In other words, the laser processing apparatus 100b of this embodiment enables different manufacturing process conditions with the first beam 112 and the second beam 114. Variety of manufacturing process is therefore enriched.

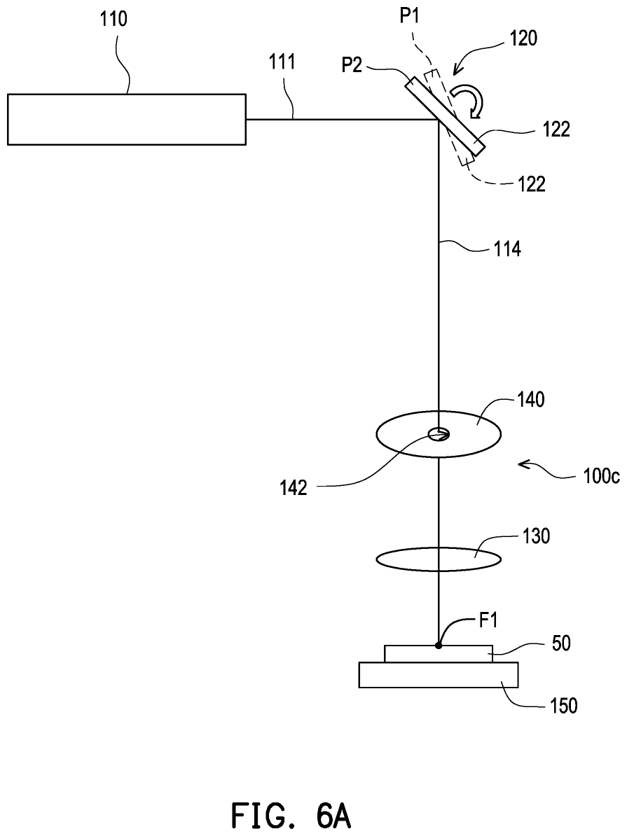

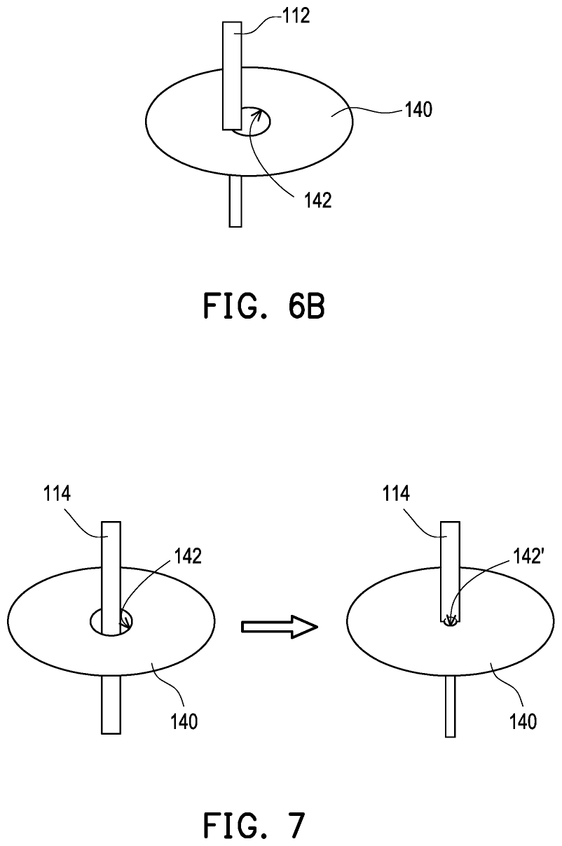

FIG. 6A is a schematic view of a light path of a second beam of a laser processing apparatus according to still another embodiment of this disclosure. FIG. 6B is a schematic view of a partial light path of a first beam of the laser processing apparatus in FIG. 6A. As FIG. 6A and FIG. 6B indicate, a laser processing apparatus 100c of this embodiment is similar to the laser processing apparatus 100 in FIG. 1. The major difference between the laser processing apparatus 100 and the laser processing apparatus 100c is described as follows. In the laser processing apparatus 100c of this embodiment, the vibration mirror module 120 in the second mode reflects the second beam 114 to the center of the aperture 142, allowing the majority or entirety of the second beam 114 to pass through the aperture 142 without being blocked by the mask 140. Hence, laser energy cast upon the to-be-processed device 50 is more robust. Alternatively, the vibration mirror module 120 in the first mode reflects the first beam 112 onto the edge of the aperture 142. As a result, a portion of the first beam 112 is blocked by the mask 140 and therefore cannot be transmitted upon the to-be-processed device 50. The rest of the first beam 112 passes through the aperture 142 before being transmitted upon the to-be-processed device 50. In this case, energy cast upon to-be-processed device 50 is less robust. With the vibration mirror module 120 switching between the first mode and the second mode, the laser processing apparatus 100c of this embodiment modulates laser energy cast upon the to-be-processed device 50. In another embodiment illustrated by FIG. 7, by lowering the aperture 142 of the mask 140 into an aperture 142′ smaller than the aperture 142 in size, to allow only a portion of the second beam 114 (or the first beam 112) to pass the through aperture 142′ while the rest of the second beam 114 (or the first beam 112) is blocked by the mask 140 around the aperture 142′, the laser energy cast upon the to-be-processed device 50 is also modulated.

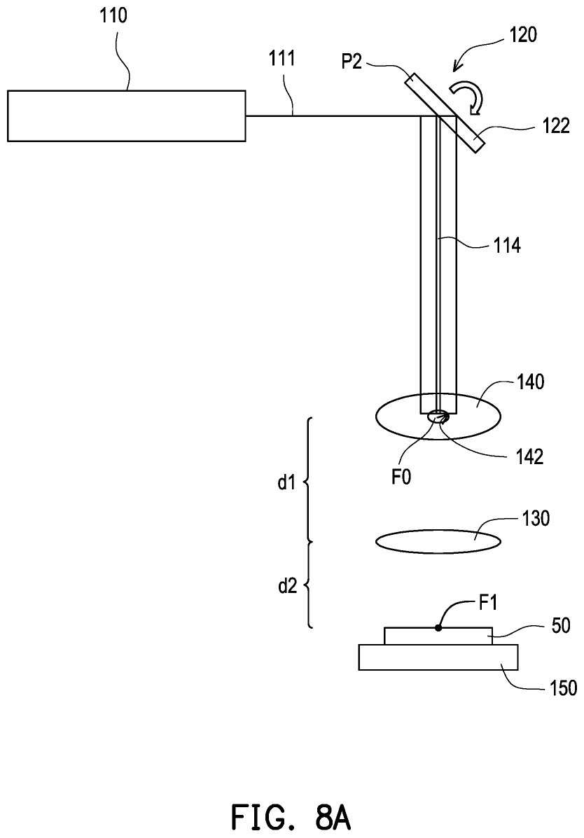

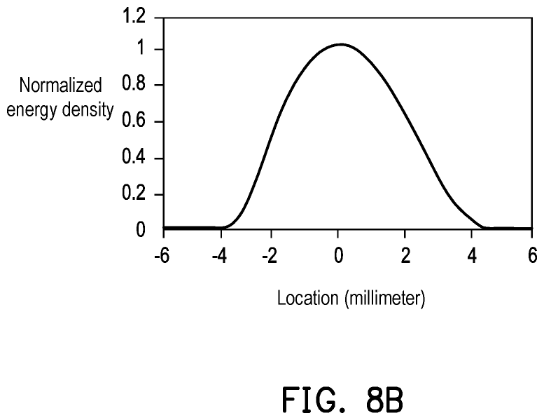

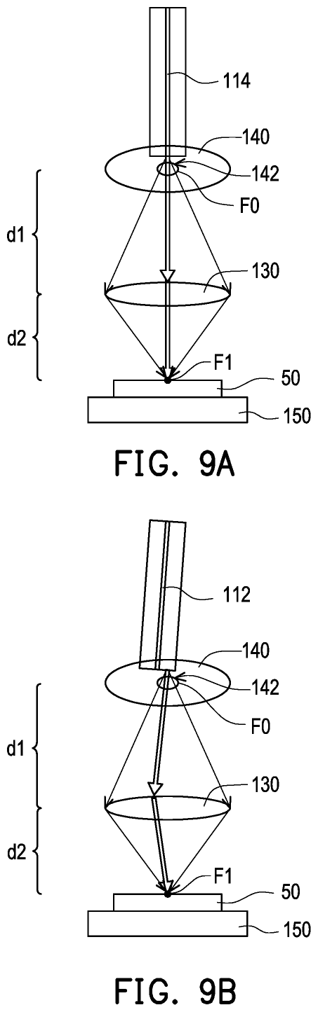

FIG. 8A is a schematic view of a light path of the second beam 114 emitted by the laser processing apparatus 110 according to another embodiment of this disclosure. FIG. 8B is a diagram showing a distribution curve of normalized light density of the laser pulse beam 111 versus cross-sectional location in the laser processing apparatus 110 in FIG. 8A. FIG. 9A is a schematic view of a partial light path of the second beam reflected by a vibration mirror module in FIG. 8A in a second mode. FIG. 9B is a schematic view of a partial light path of a first beam reflected by the vibration mirror module in FIG. 8A in a first mode. As FIG. 8A, FIG. 8B, FIG. 9A, and FIG. 9B indicate, a laser processing apparatus 100d of this embodiment is similar to the laser processing apparatus 100 in FIG. 1. Major difference between the laser processing apparatus 100d and the laser processing apparatus 100 is described as follows. In the laser processing apparatus 100d of this embodiment, the sectional energy of the laser pulse beam 111 exhibits a non-uniform distribution, e.g., Gaussian distribution, as depicted in FIG. 8B. The cross-sectional area of the laser pulse beam 111 is larger than the cross-sectional area of the aperture 142. In FIG. 8B, a location 0 is the central axis of beam 111, and locations to the left or right are different locations of the section of the laser pulse beam 111 along the radial direction, that is, locations in different distances from the central axis.

Modulated by the vibration mirror module 120, the section of the first beam 112 or the second beam 114 partially or entirely overlaps the aperture 142. In this embodiment, the vibration mirror module 120 in the first mode renders energy density of the portion of the first beam 112 that passes through the aperture 142 different from that of the portion of the second beam 114 that passes through the aperture while vibration mirror module 120 is in the second mode. Moreover, the vibration mirror module 120 switches between the first mode and the second mode in order to alter the energy of the laser pulse beam 111 that passes through the focusing module 130. In this embodiment, the focusing module 130 has the front focus F0 on a side close to the vibration mirror module 120. The front focus F0 and the focus F1 are two conjugate focuses, and the aperture 142 is provided at the front focus F0. A distance between the aperture 142 and the focusing module 130 is d1, and a distance between the to-be-processed device 50 and the focusing module 130 is d2. Hence, even if the first beam 112 enters the aperture 142 at an inclination angle, the first beam 112 traveling from the front focus F0 still returns to the focus F1 through the convergence of the focusing module 130. That is, first beam 112 and the second beam 114 are both converged onto the focus F1. However, given that the sectional energy of the laser pulse beam 111 exhibits a non-uniform distribution, e.g., Gaussian distribution, modulated by the vibration mirror module 120, the portion of the first beam 112 passing through the aperture 142 is the edge portion with less robust energy density, whereas the portion of the second beam 114 passing through the aperture 142 is the central portion with more robust energy density. As a result, the first beam 112 brings lower energy onto the focus F1 while the second beam 114 provides the focus F1 with higher energy. Aided by the vibration mirror module 120 switching between the first mode and the second mode, the laser processing apparatus 100d of this embodiment is able to modulate the optical energy received by the to-be-processed device 50 and also ensures that the focus F1 stays on the same location. Thus, in laser processing, for manufacturing process wherein multiple to-be-processed devices 50 on the processing platform 150 are processed in succession, repetitive repositioning or aiming is eliminated.

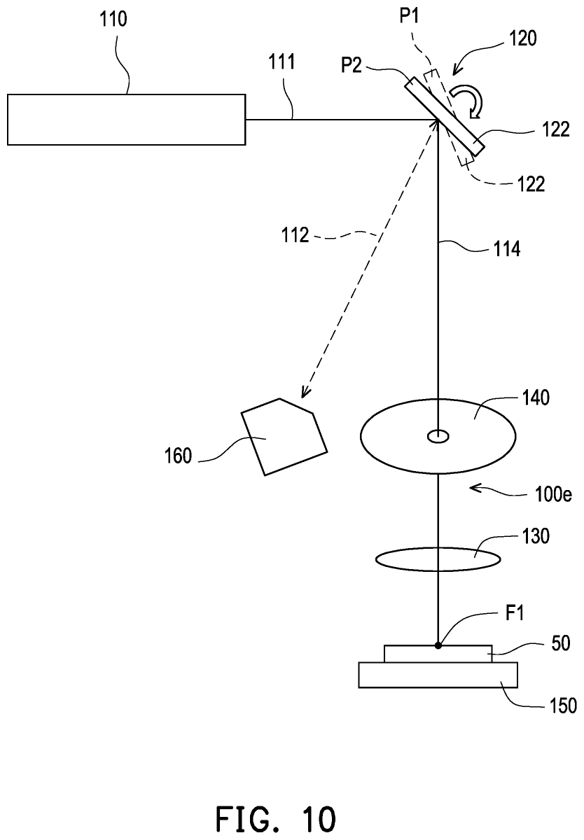

FIG. 10 is a schematic view of a light path of a laser processing apparatus according to yet another embodiment of this disclosure. As FIG. 10 indicates, a laser processing apparatus 100e of this embodiment is similar to the laser processing apparatus 100 in FIG. 1 and is also similar to the laser processing apparatus 100a in FIG. 4. The major difference is that the laser processing apparatus 100e of this embodiment has both the mask 140 in FIG. 1 and the light absorber 160 in FIG. 4. In the first mode, the vibration mirror module 120 reflects the first beam 112 onto the light absorber 160.

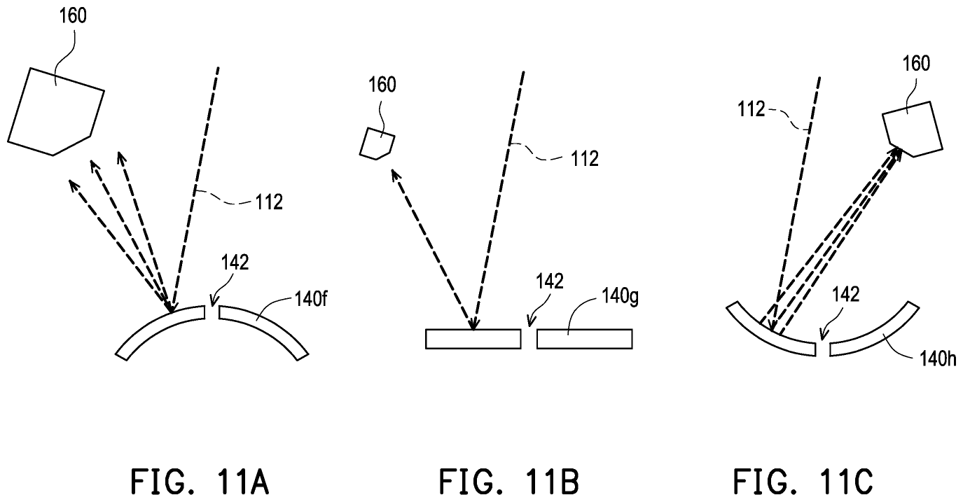

FIG. 11A, FIG. 11B, and FIG. 11C are schematic cross-sectional views of a partial light path of a first beam in three other modified examples of the laser processing apparatus in FIG. 10. As FIG. 11A indicates, in this embodiment, a mask 140f is a curved reflective lens, which alters the angle of reflection of the first beam 112 or a portion of the second beam 114. Besides, the light absorber 160 is positioned on the path of light (e.g., the first beam 112 or a portion of the second beam 114) reflected off the curved reflective lens. In FIG. 11A, the curved reflective lens is a convex lens element while in FIG. 11C, a mask 140h is a concave lens element. In FIG. 11B, a mask 140g is a plane lens element. The mask 140g and the mask 140h are both capable of reflecting the first beam 112 or a portion of the second beam 114 onto the light absorber 160. By adopting the reflecting lens elements, the mask 140f, the mask 140g, and the mask 140h avoid changes in temperature resulted from optical energy absorption and also prevent the aperture 142 from changing its shape or size due to the changes in temperature. Consequently, precision and stability of manufacturing process are effectively improved.

In a nutshell, in the laser processing apparatus of the disclosed embodiments, a vibration mirror module selectively reflects a laser pulse beam into a first beam while being in the first mode or selectively reflects a laser pulse beam into a second beam while being in the second mode As a result, the laser processing apparatus is able to reflect the second beam with stable energy onto a focusing module for focusing. Stability of manufacturing process is therefore enhanced. Variety of manufacturing process is also enriched since the laser processing apparatus in the disclosed embodiments enables different manufacturing process conditions with the first beam and the second beam.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A laser processing apparatus, comprising:
a laser unit, configured to emit a laser pulse beam;
a vibration mirror module, positioned on a path of the laser pulse beam, configured to reflect the laser pulse beam and having a first mode and a second mode configured to selectively reflect the laser pulse beam into a first beam while the vibration mirror module is in the first mode or to selectively reflect the laser pulse beam into a second beam while the vibration mirror module in the second mode, wherein the first beam and the second beam travel in different directions;
a focusing module, which receives the second beam reflected by the vibration mirror module in the second mode and focuses the second beam onto a focus;
a mask, positioned between the vibration mirror module and the focusing module, comprising an aperture to enable at least a portion of the second beam to pass through; and
a processing platform, positioned at the focus, and configured to bear a to-be-processed device, wherein the second beam is cast upon the to-be-processed device.

2. The laser processing apparatus according to claim 1, wherein the laser pulse beam emitted by the laser unit comprises a first laser pulse beam and a second laser pulse beam, with energy of the first laser pulse beam less than energy of the second laser pulse beam, the first laser pulse beam being reflected by the vibration mirror module in the first mode, and the second laser pulse beam being reflected by the vibration mirror module in the second mode.

3. The laser processing apparatus according to claim 1, wherein the laser pulse beam emitted by the laser unit comprises a plurality of laser pulse beams with a first frequency, and, in a second frequency, the vibration mirror module switches between the first mode and the second mode.

4. The laser processing apparatus according to claim 3, wherein the second frequency is smaller than the first frequency, and the second mode overlaps time sequence of at least one of the laser pulse beams with the first frequency.

5. The laser processing apparatus according to claim 1, wherein an incident angle configured in the vibration mirror module for the first beam to enter the focusing module in the first mode is different from an incident angle configured in the vibration mirror module for the second beam to enter the focusing module in the second mode, and the vibration mirror module switches between the first mode and the second mode in order to alter a location of the focus on a focusing plane.

6. The laser processing apparatus according to claim 1, wherein sectional energy of the laser pulse beam exhibits a non-uniform distribution, a cross-sectional area of the laser pulse beam is larger than a cross-sectional area of the aperture, energy density of a portion of the first beam configured to pass through the aperture in the vibration mirror module in the first mode is different from energy density of a portion of the second beam configured to pass through the aperture in the second mode, and the vibration mirror module switches between the first mode and the second mode to alter energy of the laser pulse beam passing through the focusing module.

7. The laser processing apparatus according to claim 6, wherein the focusing module is further provided with a front focus on a side close to the vibration mirror module, the front focus and the focus are two conjugate focuses, and the aperture is positioned at the front focus.

8. The laser processing apparatus according to claim 1, further comprising a light absorber positioned on a light path of the first beam.

9. The laser processing apparatus according to claim 1, wherein the mask is a light absorber configured to absorb the first beam or a portion of the second beam.

10. The laser processing apparatus according to claim 1, wherein the mask is a curved reflective lens, which alters an angle of reflection of the first beam or a portion of the second beam, and the laser processing apparatus further comprises a light absorber positioned on a path of light reflected off the curved reflective lens.

11. A laser processing apparatus, comprising:
a laser unit, configured to emit a laser pulse beam, wherein the laser pulse beam comprises a first laser pulse beam and a second laser pulse beam, with energy of the first laser pulse beam weaker than energy of the second laser pulse beam;
a vibration mirror module, positioned on a path of the laser pulse beam, configured to reflect the laser pulse beam and having a first mode and a second mode configured to selectively reflect the first laser pulse beam into a first beam while the vibration mirror module is in the first mode or to selectively reflect the second laser pulse beam into a second beam while the vibration mirror module is in the second mode, wherein the first beam and the second beam travel in different directions;
a focusing module, which receives the second beam reflected by the vibration mirror module in the second mode and focuses the second beam onto a focus; and
a processing platform, positioned at the focus, and configured to bear a to-be-processed device, wherein the second beam is cast upon the to-be-processed device.

12. The laser processing apparatus according to claim 11, wherein the laser pulse beam emitted by the laser unit comprises a plurality of laser pulse beams with a first frequency, and, in a second frequency, the vibration mirror module switches between the first mode and the second mode.

13. The laser processing apparatus according to claim 12, wherein the second frequency is smaller than the first frequency, and the second mode overlaps time sequence of at least one of the laser pulse beams with the first frequency.

14. The laser processing apparatus according to claim 11, further comprising a light absorber positioned on a light path of the first beam.

15. The laser processing apparatus according to claim 11, wherein an incident angle configured in the vibration mirror module for the first beam to enter the focusing module in the first mode is different from an incident angle configured in the vibration mirror module for the second beam to enter the focusing module in the second mode, and the vibration mirror module switches between the first mode and the second mode in order to alter a location of the focus on a focusing plane.

16. The laser processing apparatus according to claim 11, wherein the focusing module is further provided with a front focus on a side close to the vibration mirror module, the front focus and the focus are two conjugate focuses, and the front focus overlaps a convergence point of the laser pulse beam and the vibration mirror module.
